(19) United States
(12) Patent Application Publication
(10) Pub. No.: US 2021/0269930 A1
(43) Pub. Date: Sep. 2, 2021

(54) PRODUCING LITHIUM FILM USING CIRCULATION OF ORGANIC ELECTROLYTE

(71) Applicant: ALPHA-EN CORPORATION, Yonkers, NY (US)

(72) Inventors: Lawrence Ralph SWONGER, Lititz, PA (US); Naba K. KARAN, Vernon, CT (US)

(21) Appl. No.: 17/255,655

(22) PCT Filed: Jun. 28, 2019
(86) PCT No.: PCT/US2019/039892

§ 371 Date: Dec. 23, 2020

Related U.S. Application Data
(60) Provisional application No. 62/691,226, filed on Jun. 28, 2018.

(51) Int. Cl. C25D 3/54; H01M 4/04; H01M 4/1395; H01M 4/38

(52) U.S. Cl. CPC C25D 3/54; H01M 4/382; H01M 4/1395; H01M 4/0452

(57) ABSTRACT

A method of forming a lithium metal film is provided. In a general embodiment, the present disclosure provides a deposition cell comprising an anode and a substrate provided within the deposition cell. A lithium ion containing electrolyte is flowed across a surface of the substrate, and a voltage is applied to the substrate to deposit a lithium metal film onto the substrate from the lithium ion containing electrolyte. The voltage is controlled to be substantially constant within a range of −3.7 to −4 volts relative to an AgCl/Ag reference electrode or a constant current is used that stabilizes within a voltage range of −3.7 to −4 volts relative to an AgCl/Ag reference electrode. The present method can advantageously form a lithium metal film that has an optically smooth surface morphology and nano-rod structures.

### FIELD OF TECHNOLOGY

The present disclosure generally relates to systems and processes for producing lithium. More specifically, for example, the present disclosure relates to a method of forming a lithium metal film, comprising flowing a lithium ion containing electrolyte across a surface of the substrate within a lithium producing cell. Additionally the present disclosure also relates to processes for plating lithium onto a substrate. In an embodiment, the voltage is controlled to be substantially constant within a range of −3.7 to −4 volts relative to an AgCl/Ag reference electrode or a constant current is used that stabilizes within a voltage range of −3.7 to −4 volts relative to an AgCl/Ag reference electrode.

### BACKGROUND

Lithium is a soft, silver-white metal belonging to the alkali metal group of chemical elements. Lithium is highly reactive and flammable, though it is the least reactive of the alkali metals. Because of its high reactivity, lithium does not occur freely in nature. Instead, lithium only appears naturally in compositions, usually ionic in nature. Therefore, lithium metal can be obtained only by extraction of lithium from such compounds containing lithium.

### SUMMARY

Currently, lithium can be obtained by electrolytically depositing lithium on a cathode. The sample to be plated with lithium is submersed in the organic electrolyte that is separated from the aqueous compartment by making use of a lithium ion conducting solid, such as a lithium ion conductive glass-ceramic (LiC-GC) separator plate. When potential is applied to the cell, lithium ions migrate from the aqueous electrolyte, through the LiC-GC separator plate into the organic electrolyte, and lithium is plated onto the substrate from the organic electrolyte.

In one non-limiting aspect, the present disclosure relates to a method of forming a lithium metal film using circulation of the organic electrolyte. The method includes providing a deposition cell comprising an anode and a substrate provided within the deposition cell. A lithium ion containing organic electrolyte is flowed across a surface of the substrate, and a voltage is applied to the substrate to deposit a lithium metal film onto the substrate from the lithium ion containing electrolyte. In an embodiment, the voltage is controlled to be substantially constant within a range of −3.7 to −4 volts relative to an AgCl/Ag reference electrode or a constant current is used that stabilizes within a voltage range of −3.7 to −4 volts relative to an AgCl/Ag reference electrode.

In each or any of the above- or below-mentioned embodiments, the voltage may be controlled to be substantially constant within a range of −3.75 to −3.95 volts relative to an AgCl/Ag reference electrode or a constant current is used that stabilizes within a voltage range of −3.75 to −3.95 volts relative to an AgCl/Ag reference electrode.

In each or any of the above- or below-mentioned embodiments, the voltage may be controlled to be substantially constant within a range of −3.75 to −3.85 volts relative to an AgCl/Ag reference electrode or a constant current is used that stabilizes within a voltage range of −3.75 to −3.85 volts relative to an AgCl/Ag reference electrode.

In each or any of the above- or below-mentioned embodiments, the lithium ion containing electrolyte may comprise a mixture of dimethyl carbonate and lithium hexafluorophosphate, or the lithium ion containing electrolyte may comprise a conventional electrolyte typically used in Li-ion or Li-metal batteries including, but not limited to, a mixture of a lithium salt (e.g., lithium hexafluorophosphate (LiPF₆), lithium bis(trifluoromethanesulfonyl) imide (LiTFSI), lithium bis(fluorosulfonyl) imide (LiFSI), or lithium bis(oxalate) borate) (LiBOB)) dissolved in a solvent such as ethers (e.g., diethyl ether or tetrahydrofuran), amides (e.g., dimethylformamide or N-methyl-2-pyrrolidone), sulfones (dimethyl sulfone), ionic liquids, or dimethyl sulfoxide. In each or any of the above- or below-mentioned embodiments, the lithium ion containing electrolyte may comprise a mixture of a solvent and a lithium salt, wherein the solvent is selected from the group consisting of ethers, diethyl ether, tetrahydrofuran, amides, dimethylformamide, N-methyl-2-pyrrolidone), sulfones, dimethyl sulfone, ionic liquids, and dimethyl sulfoxide, and the lithium salt is selected from the group consisting of lithium hexafluorophosphate, preferably wherein the lithium ion containing electrolyte comprises a mixture of dimethyl carbonate and lithium hexafluorophosphate

In each or any of the above- or below-mentioned embodiments, the substrate may be a conductive substrate, such as copper. In each or any of the above- or below-mentioned embodiments, the substrate may comprise a substantially planar body portion.

In each or any of the above- or below-mentioned embodiments, the deposition cell may be configured to further receive an aqueous electrolyte, and the deposition cell may comprise a lithium ion conductive glass ceramic that separates the lithium ion containing electrolyte from the aqueous electrolyte.

In each or any of the above- or below-mentioned embodiments, the deposition cell may include opposing cathode and anode sides separated by the lithium ion conductive glass ceramic, the lithium ion containing organic electrolyte may be circulated through the cathode side of the deposition cell, and the aqueous electrolyte may be circulated through the anode side of the deposition cell.

In each or any of the above- or below-mentioned embodiments, the aqueous electrolyte may comprise lithium carbonate dissolved in sulfuric acid.

In each or any of the above- or below-mentioned embodiments, the lithium ion conductive glass ceramic may be an ion conductive glass-ceramic having the following composition in mol percent: P₂O₅ 26-55%; SiO₂ 0-15%; GeO₂+TiO₂ 25-50%; in which GeO₂ 0-50%; TiO₂ 0-50%; ZrO₂ 0-10%; M₂O₃ 0-10%; Al₂O₃ 0-15%; Ga₂O₃ 0-15%; Li₂O₃-25% and containing a predominant crystalline phase comprising Li₁₊ₓ(M, Al, Ga)ₓ(Ge_{1-y}Ti_{y})₂₋ₓ(PO₄)₃ where X≤0.8 and 0≤Y≤1 and where M is an element selected from the group consisting of Nd, Sm, Eu, Gd, Tb, Dy, Ho, Er, Tm and Yb, and/or Li_{1+x+y}QₓTi₂₋ₓSi₃P_{3-y}O₁₂ where 0<X≤0.4 and 0<Y≤0.6, and where Q is Al or Ga.

In each or any of the above- or below-mentioned embodiments, the aqueous electrolyte may be continuously circulated to the deposition cell.

In each or any of the above- or below-mentioned embodiments, the lithium ion containing electrolyte may be continuously circulated to the deposition cell.

In each or any of the above- or below-mentioned embodiments, the lithium metal film may have an optically smooth surface morphology.

In each or any of the above- or below-mentioned embodiments, the lithium metal film may comprise nano-rod structures.

In each or any of the above- or below-mentioned embodiments, the lithium metal film may have a purity of at least 99.96 weight percent on a metals basis.

In each or any of the above- or below-mentioned embodiments, the lithium metal film may have a purity of at least 99.99 weight percent on a metals basis.

In each or any of the above- or below-mentioned embodiments, the lithium metal film may have a purity of at least 99.998 weight percent on a metals basis.

In each or any of the above- or below-mentioned embodiments, the lithium metal film may be free of metal impurities.

In each or any of the above- or below-mentioned embodiments, the substrate may comprise copper.

In each or any of the above- or below-mentioned embodiments, a surface of the lithium metal film may measure approximately 25 cm² or less. In each or any of the above- or below-mentioned embodiments, a surface of the lithium metal film may measure approximately 9 cm² to 25 cm².

In each or any of the above- or below-mentioned embodiments, a surface of the lithium metal film measures approximately 25 cm² or more. In each or any of the above- or below-mentioned embodiments, a surface of the lithium metal film measures approximately 100 cm² to 500 cm², approximately 200 cm² to 300 cm², or approximately 225 cm² to 250 cm².

An advantage of the present disclosure is to improve the consistency in forming a lithium metal film and to promote growth of an optically smooth surface morphology and nano-rod structures within the lithium metal film.

Additional features and advantages are described herein, and will be apparent from the following Detailed Description and the figures.

### BRIEF DESCRIPTION OF THE FIGURES

FIG. 1 is a perspective view of a lithium producing cell according to an embodiment of the present disclosure.

FIG. 2 is an exploded view of the lithium producing cell of FIG. 1.

FIGS. 3A and 3B are images of relatively thin (less than 5 μm) plated lithium samples with no circulation in the organic compartment.

FIG. 4 is an image of a relatively thick plated lithium sample (˜18 μm) prepared with no organic electrolyte flow.

FIG. 5 is an image of a relatively thick plated lithium sample (˜40 μm) with circulation in the organic component, demonstrating substantially improved uniformity of the plated thicker lithium films by the introduction of circulation in the organic compartment.

### DETAILED DESCRIPTION

The terminology used herein is for the purpose of describing particular embodiments only and is not intended to be limiting. As used in the specification and the appended claims, the singular forms “a,” “and” and “the” include plural references unless the context clearly dictates otherwise.

For the recitation of numeric ranges herein, each intervening number therebetween with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

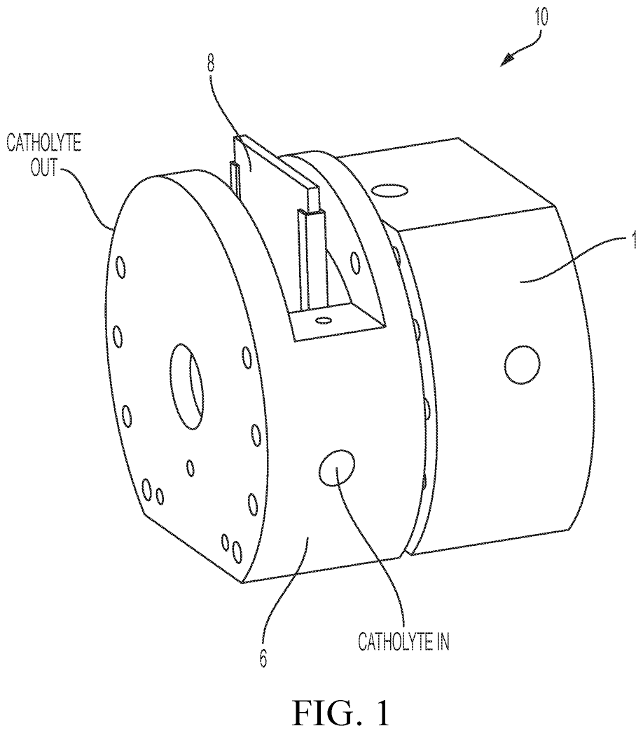

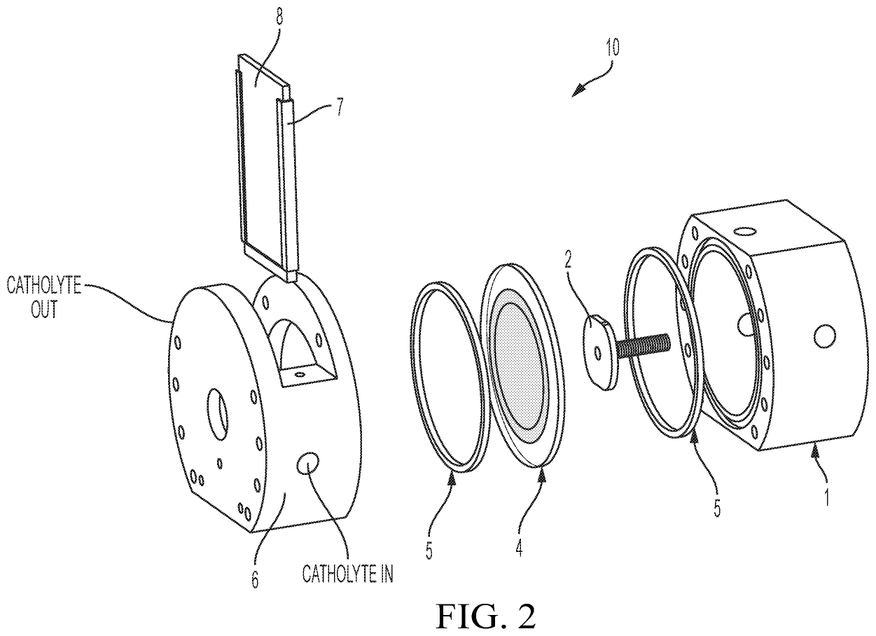

The present disclosure generally relates to a method of forming a lithium metal film, comprising flowing a lithium ion containing electrolyte across a surface of the substrate within a lithium producing cell. Referring initially to FIGS. 1 and 2, the illustrated embodiment of the deposition cell 10 for producing lithium includes an anode 2 and a substrate (not shown) provided within the deposition cell 10. The anode 2 can be made from platinum. The cell body can be made of a suitably rigid material such as polypropylene. The lithium producing systems and processes described herein are not limited in this regard. In an embodiment, a lithium ion containing electrolyte (not shown) is flowed or circulated across a surface of the substrate, and a voltage is applied to the substrate to deposit a lithium metal film onto the substrate from the lithium ion containing electrolyte.

As used herein, a “lithium ion containing electrolyte,” “organic electrolyte,” or “catholyte” refers to a fluid conveying lithium ions to the cathode. In an embodiment, the lithium ion containing electrolyte comprises a mixture of dimethyl carbonate and lithium hexafluorophosphate (DMC-LiPF₆) or an equivalent compatible electrolyte, including standard electrolytes used in lithium ion and lithium metal batteries. The lithium producing systems and processes described herein are not limited in this regard. In an embodiment, the lithium producing system may be a dual compartment electrolytic cell. In the illustrated embodiment, the deposition cell 10 is configured to further receive an aqueous electrolyte, and the deposition cell 10 comprises a lithium ion conductive glass ceramic (i.e., a glass ceramic membrane bonding onto a glass plate) 4 that separates the lithium ion containing electrolyte from the aqueous electrolyte. The aqueous electrolyte may comprise lithium carbonate dissolved in sulfuric acid, but alternatives are also acceptable. In an embodiment, the deposition cell 10 includes a cathode (organic) compartment 6 opposing the anode (aqueous) compartment 1 and separated by the lithium ion conductive glass ceramic 4. According to certain non-limiting embodiments, the lithium ion containing electrolyte is circulated through the cathode compartment 6 of the deposition cell 10, and the aqueous electrolyte is circulated through the anode compartment 1 of the deposition cell. According to various other non-limiting embodiments, the lithium ion containing electrolyte, the aqueous electrolyte, or both are continuously fed or circulated to the deposition cell 10. In an embodiment, the deposition cell 10 comprises an anode 2, which may be platinum-plated niobium. In an embodiment, the deposition cell 10 comprises O-rings 5.

In certain non-limiting embodiments, the lithium ion conductive glass ceramic 4 is an ion conductive glass-ceramic having the following composition in mol percent: P₂O₅ 26-55%; SiO₂ 0-15%; GeO₂+TiO₂ 25-50%; in which GeO₂ 0-50%; TiO₂ 0-50%; ZrO₂ 0-10%; M₂O₃ 0-10%; Al₂O₃ 0-15%; Ga₂O₃ 0-15%; Li₂O₃-25% and containing a predominant crystalline phase comprising Li₁₊ₓ(M, Al, Ga)ₓ(Ge_{1-y}Ti_{y})₂₋ₓ(PO₄)₃ where X≤0.8 and 0≤Y≤1 and where M is an element selected from the group consisting of Nd, Sm, Eu, Gd, Tb, Dy, Ho, Er, Tm and Yb, and/or Li_{1+x+y}QₓTi₂₋ₓSi₃P_{3-y}O₁₂ where 0<X≤0.4 and 0<Y≤0.6, and where Q is Al or Ga. Other examples include 11A1203, Na₂O.11Al₂O₃, (Na, Li)₁₊ₓTi₂₋ₓAlₓ(PO₄)₃ (0.6≤x≤0.9) and crystallographically related structures, Na₃Zr₂Si₂PO₁₂, Li₃Zr₂Si₂PO₄, Na₅ZrP₃O₁₂, Na₅TiP₃O₁₂, Na₃Fe₂P₃O₁₂, Na₄NbP₃O₁₂, Li₅ZrP₃O₁₂, Li₅TiP₃O₁₂, Li₅Fe₂P₃O₁₂ and Li₄NbP₃O₁₂ and combinations thereof, optionally sintered or melted. Suitable ceramic ion active metal ion conductors include, for example, a product from Ohara, Inc. (Kanagawa, JP), trademarked LIC-GC™, LISICON, Li₂O—Al₂O₃—SiO₂—P₂O₅—TiO₂ (LATP). Suitable material with similarly high lithium metal ion conductivity and environmental/chemical resistance are manufactured by Ohara and others.

According to certain non-limiting embodiments, the substrate to be plated with lithium is provided within the deposition cell 10. In some embodiments, the substrate comprises copper. In other embodiments, however, lithium may be deposited onto alternative substrates. In some embodiments, the substrate comprises a substantially planar body portion. In other embodiments, however, the substrate may assume any other suitable geometric form. In some embodiments, the substrate may be fixedly or removably attached to a sample holder 8 that houses the cathode. In other embodiments, the substrate may be hung freely in the lithium ion containing electrolyte, e.g., using alligator clips and not using the sample holder 8. In some embodiments, the deposition cell 10 may comprise a fixture 7 to house the sample holder.

When a voltage is applied across the deposition cell 10, lithium ions migrate from the aqueous electrolyte, through the lithium ion conductive glass ceramic 4, into the lithium ion containing electrolyte, and lithium plates onto the substrate from the lithium ion containing organic electrolyte. In an embodiment the voltage is controlled to be substantially constant within a range of −3.7 to −4 volts relative to an AgCl/Ag reference electrode. According to certain non-limiting embodiments, the voltage is controlled to be substantially constant within a range of −3.75 to −3.95 volts relative to an AgCl/Ag reference electrode. According to various other non-limiting embodiments, the voltage is controlled to be substantially constant within a range of −3.75 to −3.85 volts relative to an AgCl/Ag reference electrode.

According to certain non-limiting embodiments, the method of the present disclosure can advantageously provide a lithium metal film that has an optically smooth surface morphology. According to various other non-limiting embodiments, the lithium metal film comprises nano-rod structures. An advantage of the present disclosure is that the production system reliability is improved in forming a lithium metal film that has an optically smooth surface morphology and nano-rod structures. The method of the present disclosure can also advantageously provide a lithium metal film that has a purity of at least 99.96 weight percent on a metals basis. In an embodiment, the lithium metal film has a purity of at least 99.99 weight percent on a metals basis. In an embodiment, the lithium metal film has a purity of at least 99.998 weight percent on a metals basis. In an embodiment, the lithium metal film is free of metal impurities. In certain non-limiting embodiments, a surface of the lithium metal film measures approximately 25 cm² or less. In an embodiment, a surface of the lithium metal film measures approximately 9 cm² to 25 cm².

The high purity smooth lithium metal thin film may be used in any application where an ultra thin, high quality lithium film is required. For example, the high purity smooth lithium metal thin film may be used in a microbattery or a low power device that requires thin high-purity lithium films having a thickness less than 40 μm. Microbatteries including the high purity smooth lithium metal thin film can be coupled to energy harvesting electronics such as piezo electronics and photovoltaics, as well as be integrated into microelectronics and nanosensors. The high purity smooth lithium metal thin film may also be used in a lithium metal anode of a battery.

Following are non-limiting examples of methods of forming a lithium metal film according to the present disclosure. Persons having ordinary skill in the art will appreciate that variations of the following examples are possible within the scope of the invention, which is defined solely by the claims.

### Example 1

Lithium films were produced on a copper substrate at a constant plating voltage of −3.75 volts relative to an AgCl/Ag reference electrode, with a stagnant organic electrolyte comprising a 1.0M solution of LiPF₆ in DMC. In other words, the organic electrolyte was not circulated. Table 1 below provides the current densities for lithium plating on various effective cathode areas.

TABLE 1
Current density for lithium plating

| Sample | 5 cm × | 4 cm × | 3 cm × |
|---|---|---|---|
| Dimensions | 5 cm | 4 cm | 3 cm |
| Max current (mA) | 128 | 102 | 56 |
| Stable current | 31 | 28 | 20 |
| (mA) | | | |
| Area (cm²) | 25 | 16 | 9 |
| Max mA/cm² | 5.12 | 6.38 | 6.22 |
| Stable mA/cm² | 1.24 | 1.75 | 2.22 |

The resultant samples initially (˜300 s) exhibited a blue color, which is indicative of a nano-rod morphology within the lithium metal film. Without wishing to be bound by any particular theory, it is believed that the blue appearance might be due to a structural coloration effect, whereby the fine microscopic surface produces a structural color by interference among light waves scattered by two or surfaces of the thin film. But each sample produced without organic electrolyte circulation degraded during further deposition (within an hour) into a grey mossy appearance, indicative of an undesirable spherical morphology within the lithium metal film.

### Example 2

Lithium films were produced on a copper substrate, with the organic electrolyte circulating gently across the surface of the sample. Aqueous electrolyte was circulated through the side ports of component 1 using a Levitronix BPS-1 pump and Teflon tubing. Organic electrolyte was circulated though the side ports of component 6 using a Levitronix BPS i100 pump and Teflon tubing. For this experiment the fixture 7 and sample holder 8 were not used. Instead the sample was simply hung into the organic electrolyte using alligator clips.

The deposition was performed in a 1.0M electrolyte solution of LiPF₆ in DMC at a constant plating voltage of −3.85 volts relative to an AgCl/Ag reference electrode. Two hours of plating resulted in an even blue lithium film across the entire surface, indicative of nano-rod morphology. Lithium deposition was confirmed by reduction in pH of the aqueous feed solution from pH 4.17 to pH 3.39, showing that lithium ions are being transported through the ion selective membrane from the aqueous electrolyte and into the organic electrolyte during lithium plating on to the coper cathode in the organic compartment. Plating voltage in these experiments was limited to −3.85 volts relative to an AgCl/Ag reference electrode to avoid excessive degradation of the 1.0M DMC-LiPF₆ electrolyte used in these trials.

### Example 3

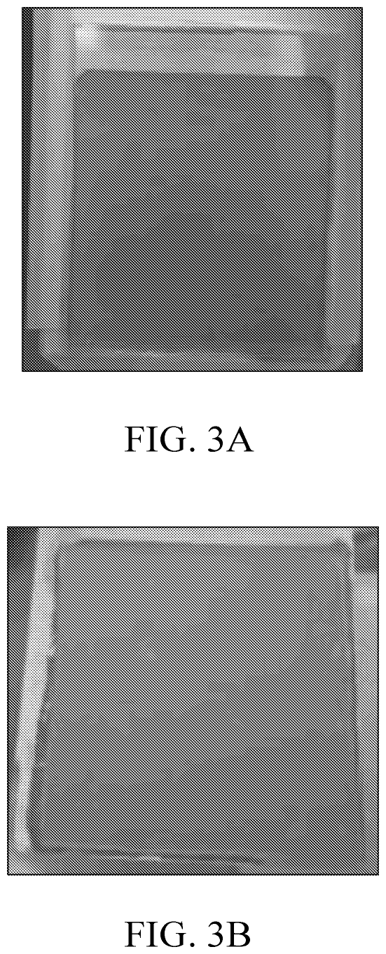

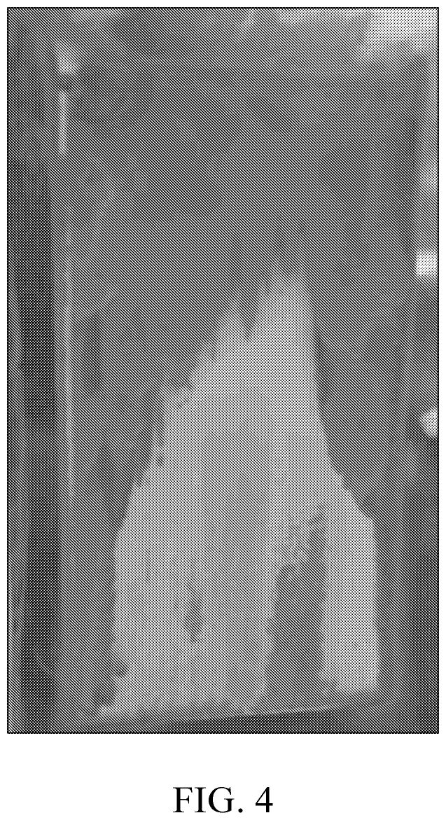

To determine the effect of flow on the quality of the lithium metal film produced, a 1M solution of LiPF₆ in ethylene carbonate (EC)/DMC (5/95% v/v) was used to perform a 300 second deposition on copper film at controlled voltage of −3.8 V (corresponding to a stabilized current of −18.89 mA), with no organic electrolyte flow. The thin film produced (FIG. 3A) was very thin, but uniform. Deposition on this sample was continued for another 3300 seconds, resulting in a fairly uniform film (FIG. 3B), with thickness of approximately 5 μm. A second experiment was performed using the same 1M solution of LiPF₆ in EC/DMC (5/95% v/v), with no organic electrolyte flow. This sample was deposited at a constant current of −15 mA (−1.1 mA/cm²) for 12000 seconds for an estimated thickness of −18 μm. This sample (FIG. 4) displayed poor uniformity. Attempts to deposit thicker films with no organic flow reproducibly produced films with poor uniformity.

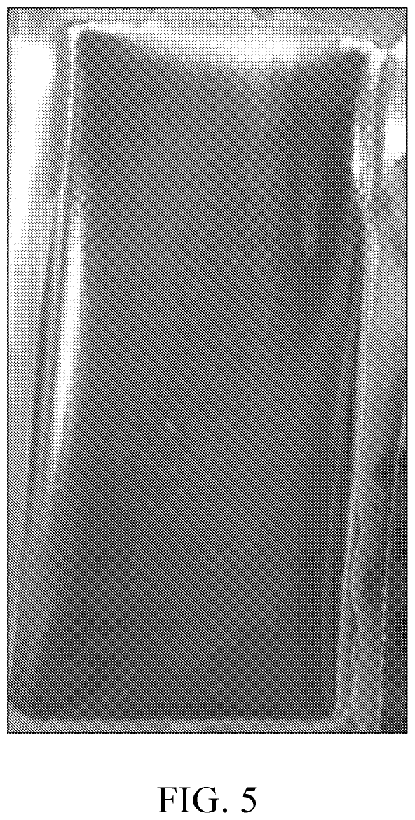

Modifications were made to the system to provide circulation of organic electrolyte within the deposition cell (425 rpm). The deposition shown in FIG. 5 was produced using a solution of 1M LiPF₆ in EC-DMC (5/95% v/v) with a total deposition time of 18000 seconds and a constant current density of 1.67 mA/cm². Estimated lithium film thickness is −40 μm. With the addition of organic electrolyte circulation these results with improved uniformity of the plated lithium films were consistently repeated.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of forming a lithium metal film, the method comprising:
providing a deposition cell comprising an anode and a substrate provided within the deposition cell;
flowing a lithium ion containing electrolyte across a surface of the substrate; and
applying a voltage to the substrate to deposit a lithium metal film onto the substrate from the lithium ion containing electrolyte, wherein the voltage is controlled to be substantially constant within a range of −3.7 to −4 volts relative to an AgCl/Ag reference electrode or a constant current is used that stabilizes within a voltage range of −3.7 to −4 volts relative to an AgCl/Ag reference electrode.

2. The method of claim 1, wherein the voltage is controlled to be substantially constant within a range of −3.75 to −3.95 volts relative to an AgCl/Ag reference electrode or a constant current is used that stabilizes within a voltage range of −3.75 to −3.95 volts relative to an AgCl/Ag reference electrode.

3. The method of claim 1, wherein the voltage is controlled to be substantially constant within a range of −3.75 to −3.85 volts relative to an AgCl/Ag reference electrode or a constant current is used that stabilizes within a voltage range of −3.75 to −3.85 volts relative to an AgCl/Ag reference electrode.

4. The method of claim 1, wherein the lithium ion containing electrolyte comprises a mixture of a solvent and a lithium salt, wherein the solvent is selected from the group consisting of ethers, diethyl ether, tetrahydrofuran, amides, dimethylformamide, N-methyl-2-pyrrolidone), sulfones, dimethyl sulfone, ionic liquids, and dimethyl sulfoxide, and the lithium salt is selected from the group consisting of lithium hexafluorophosphate, preferably wherein the lithium ion containing electrolyte comprises a mixture of dimethyl carbonate and lithium hexafluorophosphate.

5. The method of claim 1, wherein the substrate comprises a substantially planar body portion, preferably wherein the substrate is a conductive substrate, such as a copper substrate.

6. The method of claim 1, wherein the deposition cell is configured to further receive an aqueous electrolyte, and wherein the deposition cell comprises a lithium ion conductive glass ceramic that separates the lithium ion containing electrolyte from the aqueous electrolyte.

7. The method of claim 6, wherein the deposition cell includes opposing cathode and anode sides separated by the lithium ion conductive glass ceramic, wherein the lithium ion containing electrolyte is circulated through the cathode side of the deposition cell, and wherein the aqueous electrolyte is circulated through the anode side of the deposition cell.

8. The method of claim 6, wherein the aqueous electrolyte comprises lithium carbonate dissolved in sulfuric acid.

9. The method of claim 6, wherein the lithium ion conductive glass ceramic is an ion conductive glass-ceramic having the following composition in mol percent: P₂O₅ 26-55%; SiO₂ 0-15%; GeO₂+TiO₂ 25-50%; in which GeO₂ 0-50%; TiO₂ 0-50%; ZrO₂ 0-10%; M₂O₃ 0-10%; Al₂O₃ 0-15%; Ga₂O₃ 0-15%; Li₂O₃-25% and containing a predominant crystalline phase comprising Li₁₊ₓ(M, Al, Ga)ₓ(Ge_{1-y}Ti_{y})₂₋ₓ(PO₄)₃ where X≤0.8 and 0≤Y≤1 and where M is an element selected from the group consisting of Nd, Sm, Eu, Gd, Tb, Dy, Ho, Er, Tm and Yb, and/or Li_{1+x+y}QₓTi₂₋ₓSi₃P_{3-y}O₁₂ where 0<X≤0.4 and 0<Y≤0.6, and where Q is Al or Ga.

10. The method of claim 6, wherein the aqueous electrolyte is continuously circulated to the deposition cell.

11. The method of claim 1, wherein the lithium ion containing electrolyte is continuously circulated to the deposition cell.

12. The method of claim 1, wherein the lithium metal film has an optically smooth surface morphology.

13. The method of claim 1, wherein the lithium metal film comprises nano-rod structures.

14. The method of claim 1, wherein the lithium metal film has a purity of at least 99.96 weight percent on a metals basis.

15. The method of claim 1, wherein the lithium metal film has a purity of at least 99.99 weight percent on a metals basis.

16. The method of claim 1, wherein the lithium metal film has a purity of at least 99.998 weight percent on a metals basis.

17. The method of claim 1, wherein the lithium metal film is free of metal impurities.

18. The method of claim 1, wherein the substrate comprises copper.

19. The method of claim 1, wherein a surface of the lithium metal film measures approximately 25 cm² or less, preferably wherein the surface of the lithium metal film measures approximately 9 cm² to 25 cm².

20. The method of claim 1, wherein a surface of the lithium metal film measures approximately 25 cm² or more, preferably wherein the surface of the lithium metal film measures approximately 100 cm² to 500 cm², approximately 200 cm² to 300 cm², or approximately 225 cm² to 250 cm².
